(19) United States
(12) Patent Application Publication
(10) Pub. No.: US 2023/0102392 A1
(43) Pub. Date: Mar. 30, 2023

(54) STORAGE SYSTEM AND MANAGEMENT METHOD FOR STORAGE SYSTEM

(71) Applicant: Hitachi, Ltd., Tokyo (JP)

(72) Inventors: Shimpei NOMURA, Tokyo (JP); Mitsuo HAYASAKA, Tokyo (JP)

(21) Appl. No.: 17/693,175

(22) Filed: Mar. 11, 2022

(30) Foreign Application Priority Data
Sep. 29, 2021 (JP) 2021-160098

(51) Int. Cl. G06F 3/06; G06F 16/14; G06F 16/182

(52) U.S. Cl. CPC G06F 3/0667; G06F 3/061; G06F 3/067; G06F 16/14; G06F 16/182

(57) ABSTRACT

To make it possible to prefetch data generated in another site.

A file/object storage generates prefetch recommendation information regarding data stored in the file/object storage itself, on the basis of a data read request from a client or a file/object storage in another site, and transmits the prefetch recommendation information to the file/object storage in the other site. The file/object storage that has received the prefetch recommendation information generates a prefetch request on the basis of the prefetch recommendation information, acquires the data indicated by the prefetch recommendation information from the storage equipment in the site in which the data is stored, through the prefetch request, and stores the acquired data.

### BACKGROUND OF THE INVENTION

### 1. Field of the Invention

The present invention relates to a storage system and a management method for the storage system.

### 2. Description of the Related Art

There has been an increasing need for usage of data between sites as in a hybrid cloud or a combined use of edge and core sites. This background has caused increased interest in file storage systems having a file virtualization function to implement sharing of data between sites.

The file virtualization function enables a stub corresponding to a file which is located in another site, to be created in a local site, making it possible to make access to the file as if the file were in the local site. However, when a read access to the stub (file) has occurred, data of a part to be read is acquired from the other site, and this involves reduced responsiveness due to a transfer between the sites. Thus, there is a demand for a technique for achieving an improvement in the responsiveness.

U.S. patent Ser. No. 10/084,877 discloses a prefetching technique for data subjected to storage layering between on-premises and cloud locations. According to the technique disclosed in U.S. patent Ser. No. 10/084,877, the order of past data accesses to data generated in a local site is recorded in a graph database, and when a data access has occurred, next data that was accessed in the past immediately after the target data is identified from the graph database and is prefetched. The management of the order of data accesses and the prefetching are performed on a block-by-block basis in the case of block storage and on a file-by-file basis in the case of file storage.

However, an application of the technique disclosed in U.S. patent Ser. No. 10/084,877 to a function of sharing data between sites involves the following problems.

Specifically, the technique disclosed in U.S. patent Ser. No. 10/084,877 is applicable only to data generated in the local site and subjected to storage layering, and does not enable prefetching of data generated in another site.

In addition, the technique disclosed in U.S. patent Ser. No. 10/084,877 manages the order of accesses on a file-by-file basis, and thud does not enable prediction of access to part data of a file and prefetching of the part data. Prefetching on a file-by-file basis involves acquisition of even data that will not be accessed with a high probability, causing increased traffic. Thus, there is a need for prefetching of part data.

### SUMMARY OF THE INVENTION

In view of the above circumstances, the present invention has been conceived to provide a file storage system that enables prefetching of data generated in another site, and a management method for such a file storage system.

A storage system according to one aspect of the present invention includes a plurality of pieces of storage equipment each including a processor and a storage apparatus that stores data, each piece of storage equipment being provided in a corresponding one of a plurality of sites connected to one another via a network. The storage system stores pieces of the data different among the sites in a distributed manner. The storage system allows the storage equipment in each site to input or output data on the basis of a data input/output request received from a client, to or from the storage apparatus in the site at which data related to the data input/output request is stored. The storage equipment acquires data stored in the site local thereto when having received a data read request for the data stored in the local site from a client or the storage equipment in another one of the sites, and transmits the acquired data to the source of the data read request. The storage equipment transmits a data read request to the storage equipment in another one of the sites to acquire data when having received a data read request for the data stored in the other site from a client, and transmits the acquired data to the client that has made the data read request. On the basis of the data read request from the client or the storage equipment in the other site, the storage equipment generates prefetch recommendation information regarding data stored in the storage apparatus in the local site, and transmits the prefetch recommendation information to the storage equipment in the other site. The storage equipment that has received the prefetch recommendation information generates a prefetch request on the basis of the prefetch recommendation information, acquires the data indicated by the prefetch recommendation information from the storage equipment in the site in which the data is stored, through the prefetch request, and stores the acquired data.

According to embodiments of the present invention, a storage system that allows prefetching of data generated in another site and a management method for such a storage system can be implemented.

### BRIEF DESCRIPTION OF THE DRAWINGS

FIG. 1 is a diagram illustrating the hardware configuration of a file storage system according to a first embodiment of the present invention;

FIG. 2 is a diagram illustrating an example of the schematic configuration of a file/object storage of the file storage system according to the embodiment of the present invention;

FIG. 3 is a diagram illustrating an example of a file system provided by the file storage system according to the first embodiment, and examples of files shared between a plurality of sites;

FIG. 4 is a diagram illustrating an example of management information files of the file storage system according to the first embodiment;

FIG. 5 is a diagram illustrating an example of a metadata database (DB) of the file storage system according to the first embodiment;

FIG. 6 is a diagram illustrating an example of an operation log of the file storage system according to the first embodiment;

FIG. 7 is a diagram illustrating an example of an access pattern learning model of the file storage system according to the first embodiment;

FIG. 8 is a diagram illustrating an example of a learning data set of the file storage system according to the first embodiment;

FIG. 9 is a diagram illustrating an example of a high access probability data management table of the file storage system according to the first embodiment;

FIG. 10 is a flowchart for explaining an example of an access pattern model learning process of the file storage system according to the first embodiment;

FIG. 11 is a flowchart for explaining an example of an inter-site metadata search process of the file storage system according to the first embodiment;

FIG. 12 is a flowchart for explaining an example of an intra-site metadata search process of the file storage system according to the first embodiment;

FIG. 13 is a diagram illustrating an example of an inter-site metadata search result response of the file storage system according to the first embodiment;

FIG. 14 is a flowchart for explaining an example of a stub generation process of the file storage system according to the first embodiment;

FIG. 15 is a flowchart for explaining an example of a read process of the file storage system according to the first embodiment;

FIG. 16 is a flowchart for explaining an example of a prefetch request information generation process of the file storage system according to the first embodiment;

FIG. 17 is a flowchart for explaining an example of a recall response process of the file storage system according to the first embodiment;

FIG. 18 is a flowchart for explaining an example of a prefetch request process of a file storage system according to a second embodiment of the present invention;

FIG. 19 is a flowchart for explaining an example of a prefetch response process of the file storage system according to the second embodiment;

FIG. 20 is a flowchart for explaining an example of a replication process of a file storage system according to a third embodiment of the present invention;

FIG. 21 is a flowchart for explaining an example of a recall response process of the file storage system according to the third embodiment;

FIG. 22 is a flowchart for explaining an example of an access pattern model learning process of a file storage system according to a fourth embodiment of the present invention;

FIG. 23 is a diagram illustrating an example of an access pattern model management table of a file storage system according to a fifth embodiment of the present invention;

FIG. 24 is a flowchart for explaining an example of a model acquisition/update process of the file storage system according to the fifth embodiment;

FIG. 25 is a flowchart for explaining an example of a stub generation process of the file storage system according to the fifth embodiment; and

FIG. 26 is a flowchart for explaining an example of a read process of the file storage system according to the fifth embodiment.

### DESCRIPTION OF THE PREFERRED EMBODIMENTS

Hereinafter, embodiments of the present invention will be described with reference to the accompanying drawings. The following descriptions and the drawings are provided by way of example to explain the present invention, and omission and simplification will be made as appropriate for increased clarity in explanation. The present invention can also be embodied in various other forms. Each of constituent elements may be either one or more than one in number unless the number is explicitly specified.

Note that, in the drawings for explaining the embodiments, elements having the same functions are denoted by the same reference characters, and redundant description will be omitted.

The position, size, shape, range, and so on of each of constituent elements depicted in the drawings may not reflect the actual position, size, shape, range, and so on thereof for easier understanding of the invention. Accordingly, the position, size, shape, range, and so on disclosed in the drawings should not be construed as limiting the present invention.

In the following description, various types of information may be described by using the terms “table,” “list,” “queue,” and so on, but the various types of information may be expressed in other data structures. For example, an “XX table,” an “XX list,” or the like may sometimes be referred to as “XX information” to indicate that the information does not depend on the data structure. While the terms “identification information,” “identifier,” “name,” “identification (ID),” “number,” and so on may be used to describe identification information, such terms are interchangeable.

Note that the structure of each of tables described below is merely an example, and that one table may be divided into two or more tables or a part or the whole of two or more tables may constitute a single table.

In the case where there are a plurality of constituent elements that have the same or similar functions, the same reference character may be used to denote the constituent elements with different suffixes added thereto. However, in the case where such a plurality of constituent elements need not be distinguished from each other, the suffixes may be omitted in the description.

In addition, in the following description, a process that is performed by executing a program may be described. Such a program is executed by a processor (e.g., a central processing unit (CPU) or a graphics processing unit (GPU)) to perform a predetermined process while using, for example, storage resources (e.g., a memory) and/or an interface device (e.g., a communication port) as appropriate. Therefore, the processor may be regarded as an entity that performs the process. Similarly, a controller, an apparatus, a system, a computer, or a node that has the processor may be regarded as the entity that performs the process by executing the program. The entity that performs the process by executing the program may be a computation unit, and the computation unit may include a dedicated circuit (e.g., a field-programmable gate array (FPGA) or an application-specific integrated circuit (ASIC)) for performing a particular process.

Further, in the following description, the term “processor (unit)” refers to one or more processors. At least one processor is typically a microprocessor such as a CPU, but may be another type of processor such as a GPU. At least one processor may be either a single-core processor or a multi-core processor.

Moreover, at least one processor may be a processor in a broad sense, such as a hardware circuit (e.g., an FPGA or an ASIC) for performing a part or the whole of the process.

In the following description, the term “interface (unit)” refers to one or more interfaces. The one or more interfaces may be one or more communication interface devices of the same type (e.g., one or more network interface cards (NICs)), or two or more communication interface devices of different types (e.g., an NIC(s) and a host bus adapter(s) (HBA(s))).

Furthermore, in the following description, the term “memory unit” refers to one or more memories, typically a main storage device(s). At least one memory in the memory unit may be either a volatile memory or a non-volatile memory.

A program may be installed from a program source into an apparatus such as a computer. Such a program source may be, for example, a program distribution server or a computer-readable storage medium. In the case where the program source is a program distribution server, the program distribution server includes a processor and storage resources for storing the program to be distributed, and the processor of the program distribution server may deliver the program to another computer. Further, in the following description, two or more programs may be implemented as one program, and one program may be implemented as two or more programs.

The term “storage device” as used in the present disclosure may refer to one storage drive such as a hard disk drive (HDD) or a solid-state drive (SSD), a redundant array of inexpensive disks (RAID) system including a plurality of storage drives, or a plurality of RAID systems. Further, in the case where the drive is an HDD, the HDD may be, for example, a serial attached small computer system interface (SCSI) (SAS) HDD or a nearline SAS (NL-SAS) HDD.

File storage systems according to embodiments of the present invention have, for example, the following features.

Specifically, the technique disclosed in U.S. patent Ser. No. 10/084,877 has a problem in that prefetching of data generated in another site is not possible. To deal with this problem, in embodiments of the present invention, an access pattern learning model concerning data in a local site is generated in each of a plurality of sites, and when a read access has been received from another site, prefetch recommendation (hint) data is decided on the basis of the learning model, and the prefetch recommendation (hint) data is reported when a response to the read access is made.

The above features will be described with reference to a case where a request for a read access to data generated in a site 2 is received from a site 1.

(1) The site 2 generates a machine learning model of access patterns to the generated data.

(2) The site 1 creates, in a local site thereof (i.e., site 1), a stub of a file in the site 2.

(3) When the site 1 has made a read access to data in the site 2, the site 2 identifies data that will thereafter be accessed with a high probability, on the basis of the learning model.

(4) When responding to the read access from the site 1, the site 2 reports the data that will thereafter be accessed with a high probability, as prefetch recommendation (hint) data.

(5) The site 1 acquires the prefetch recommendation data as well when making a next read access to the site 2, with the storage capacity currently available in the local site and the state of caching of the data taken into consideration.

Further, the technique disclosed in U.S. patent Ser. No. 10/084,877 has a problem in that prediction of access to part data of a file and prefetching of the part data are not possible. To deal with this problem, in embodiments of the present invention, prefetching based on a model obtained by learning access patterns on an offset level is performed.

For example, a learning model of access patterns is caused to learn the offset and length of an access target in addition to an ID of an access target file. When a read access has been received from another site, the ID of a file that will be accessed with a high probability and the offset and length of relevant part data obtained as an output from the learning model are reported at the time of a response to the read access.

### First Embodiment

Hereinafter, an embodiment of the present invention will be described with reference to the accompanying drawings.

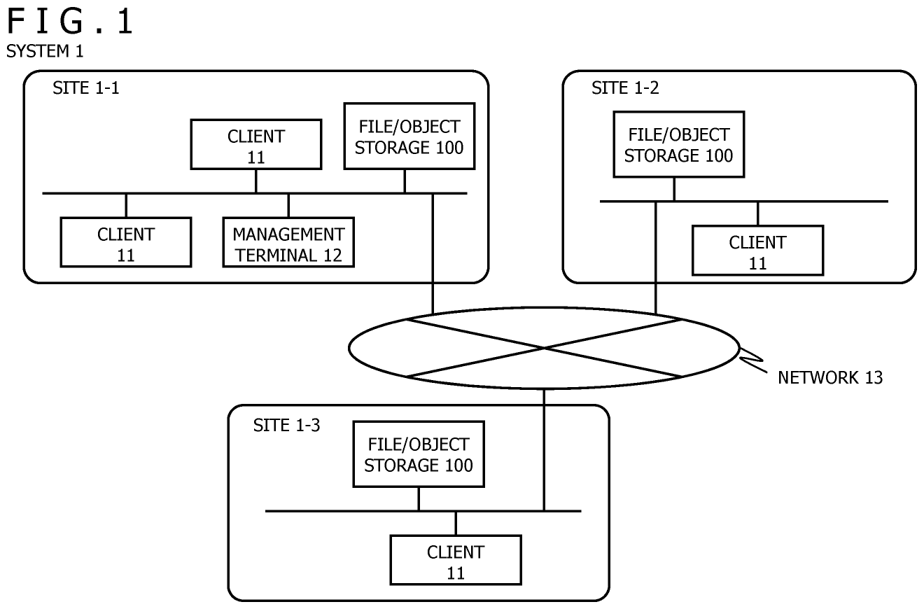

FIG. 1 is a diagram illustrating the hardware configuration of a file storage system 1 according to a first embodiment of the present invention.

The file storage system 1 according to the first embodiment has sites 1-1, 1-2, and 1-3, and the sites 1-1, 1-2, and 1-3 are connected to one another via a network 13 which is a wide area network (WAN). Note that, although the three sites 1-1, 1-2, and 1-3 are illustrated in FIG. 1, the number of sites is not limited to any particular values in embodiments of the present invention.

The site 1-1 has a file/object storage 100, clients 11, and a management terminal 12, and the file/object storage 100, the clients 11, and the management terminal 12 are connected to one another via a local area network (LAN).

The specific structure of the file/object storage 100 will be described below. Each client 11 is an information processing apparatus such as a computer capable of various types of information processing. The client 11 performs various types of file handling, for example, stores a file in the file/object storage 100 and performs file read/write processes. The management terminal 12 performs management of the file/object storage 100, and performs various types of processes, such as issuance of operation instructions, on the file/object storage 100 when an anomaly has occurred in the file/object storage 100, for example.

Each of the sites 1-2 and 1-3 also has a file/object storage 100 and a client 11. Note that the hardware configuration of each of the sites 1-1, 1-2, and 1-3 illustrated in FIG. 1 is merely an example, and that each of the sites 1-1, 1-2, and 1-3 may alternatively have another hardware configuration and the number of components included in each site may not be limited to a specific number as long as each site has at least one file/object storage 100 and at least one client 11.

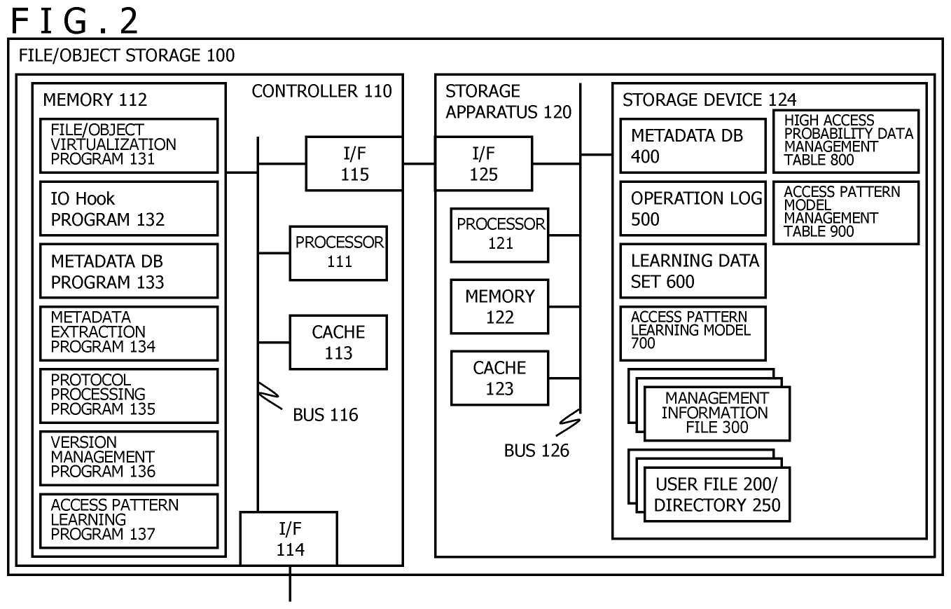

FIG. 2 is a diagram illustrating an example of the schematic configuration of the file/object storage 100 of the file storage system 1 according to the first embodiment.

The file/object storage 100 includes a controller 110 and a storage apparatus 120.

The controller 110 includes a processor 111, a memory 112, a cache 113, an interface (I/F) 114, and an interface (I/F) 115. The processor 111 controls operation of the whole file/object storage 100. The memory 112 temporarily stores data and programs used to control operation of the processor 111. The cache 113 temporarily stores data to be written from the client 11 and data read from the storage apparatus 120. The interface 114 is used for communicating with another client 11 in the site 1-1, 1-2, or 1-3 or the like. The interface 115 is used for communicating with the storage apparatus 120. The processor 111, the memory 112, the cache 113, and the interfaces 114 and 115 are connected to one another via a bus 116.

The storage apparatus 120 includes a processor 121, a memory 122, a cache 123, a storage device 124, and an interface (I/F) 125. The processor 121 controls operation of the storage apparatus 120. The memory 122 temporarily stores data and programs used to control operation of the processor 121. The cache 123 temporarily stores data to be written from the controller 110 and data read from the storage device 124. The storage device 124 stores various types of files. The interface 125 is used for communicating with the controller 110. The processor 121, the memory 122, the cache 123, the storage device 124, and the interface 125 are connected to one another via a bus 126.

The memory 112 has stored therein a file/object virtualization program 131, an IO Hook program 132, a metadata DB program 133, a metadata extraction program 134, a protocol processing program 135, a version management program 136, and an access pattern learning program 137.

The file/object virtualization program 131 monitors an operation log 500 in the storage device 124 or the like, and generates a stub file, a cached file, or a replica of a file in the storage device 124.

The IO Hook program 132 is a program for performing an IO Hook process. The IO Hook program 132 detects a file access from any client 11 and notifies the file/object virtualization program 131 of this fact. In addition, the IO Hook program 132 records an access log (not shown) on the storage device 124.

The metadata DB program 133 searches a metadata DB 400 stored in the storage device 124 of the site 1-1, 1-2, or 1-3 local thereto, on the basis of a file search request from any client 11, and notifies the file/object storage 100 of the site 1-1, 1-2, or 1-3 that has made the file search request, of a search result thereof.

The metadata extraction program 134 retrieves a user file 200 stored in the storage device 124 of the local site 1-1, 1-2, or 1-3 as appropriate, extracts metadata from the user file 200, and registers the metadata in the metadata DB 400.

The protocol processing program 135 receives various types of requests from any client 11 or the like, and processes protocols included in the requests.

The version management program 136 manages the versions of user files 200 stored in the storage device 124.

The access pattern learning program 137 generates an access pattern learning model 700, which will be described below, causes an inference operation to be performed on the basis of the access pattern learning model 700, and causes an inference result to be outputted.

The storage device 124 has stored therein the metadata DB 400, the operation log 500, a learning data set 600, the access pattern learning model 700, management information files 300, user files 200/directories 250, a high access probability data management table 800, and an access pattern model management table 900. The metadata DB 400 and so on stored in the storage device 124 will be described in detail below.

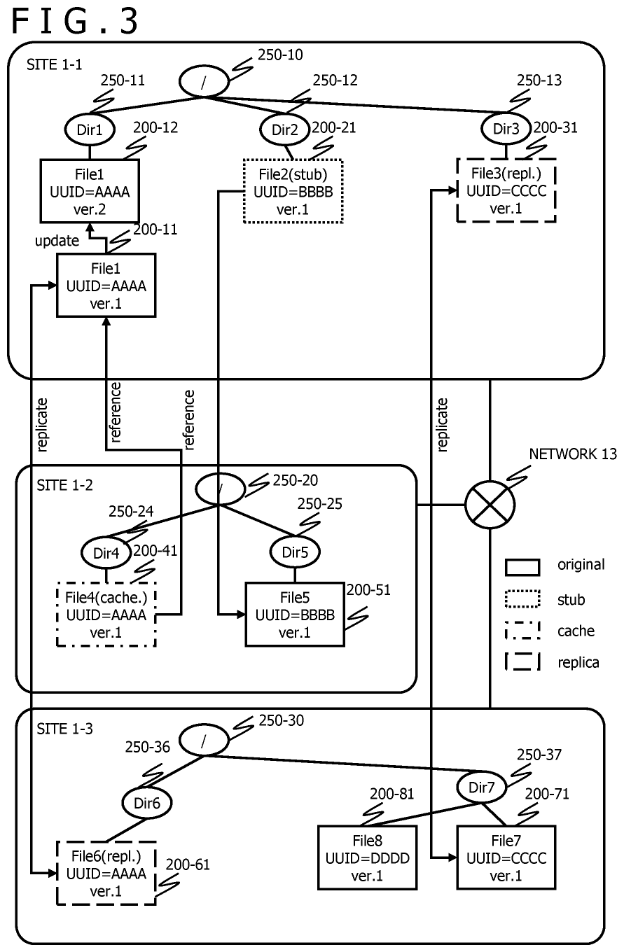

FIG. 3 is a diagram for explaining a file system provided by the file storage system 1 according to the present embodiment.

The site 1-1 (i.e., the storage apparatus 120 of the file/object storage 100 thereof) has, for example, a root directory 250-10 and directories 250-11, 250-12, and 250-13.

The directory 250-11 has, for example, files 200-11 and 200-12 stored therein. In the file storage system 1 according to the present embodiment, each of the files 200-11, 200-12, and so on is identified by a file name (path name), an identifier, and version information. The file 200-11 has, for example, a file name “File 1,” and a universally unique identifier (UUID), which is an identifier, and version information of the file 200-11 are “AAAA” and “1 (ver. 1),” respectively. The file 200-12 is an updated version (update) of the file 200-11, and version information thereof has been updated to “2 (ver. 2).” The version information is managed by the version management program 136.

In the file storage system 1 according to the present embodiment, for a substantial (denoted “original” in the figure) file (e.g., the file 200-11), a stub file (denoted “stub” in the figure), a cached file (denoted “cache” in the figure), and a replicated file (denoted “replica” in the figure) are generated by the file/object virtualization program 131 in the sites (i.e., the storage apparatuses 120 of the file/object storages 100 thereof) other than the site in which the substantial file is stored.

Here, the substantial file (original) is an original file generated in the local site. The stub file (stub) is a file for referring to data in another site, and is used, when a read request from any client 11 has been accepted, to recall the original data from the other site for caching. The cached file (cache) is a stub file with all data in the file cached. The replicated file (replica) is a replica of the original file that is made in another site for backup or other purposes. Note that, in the file storage system 1 according to the present embodiment, each of the stub file, the cached file, and the replicated file has the same UUID, i.e., identifier, as that of the original file.

The directory 250-12 has a file 200-21 stored therein. The file 200-21 is a stub file of a file 200-51 which is an original file stored in the site 1-2.

The directory 250-13 has a file 200-31 stored therein. The file 200-31 is a file obtained by replicating a file 200-71 stored in the site 1-3.

The site 1-2 has, for example, a root directory 250-20 and directories 250-24 and 250-25.

The directory 250-24 has, for example, a file 200-41 stored therein. The file 200-41 is a file obtained by caching the file 200-11 in the site 1-1. Meanwhile, the directory 250-25 has, for example, the file 200-51 stored therein. The file 200-21, which is a stub file of the file 200-51, is stored in the site 1-1 as described above.

The site 1-3 has, for example, a root directory 250-30 and directories 250-36 and 250-37.

The directory 250-36 has, for example, a file 200-61 stored therein. The file 200-61 is a file obtained by replicating the file 200-11 in the site 1-1. Meanwhile, the directory 250-37 has, for example, the file 200-71 and a file 200-81 stored therein. The file 200-31, which has been obtained by replicating the file 200-71, is stored in the site 1-1 as described above.

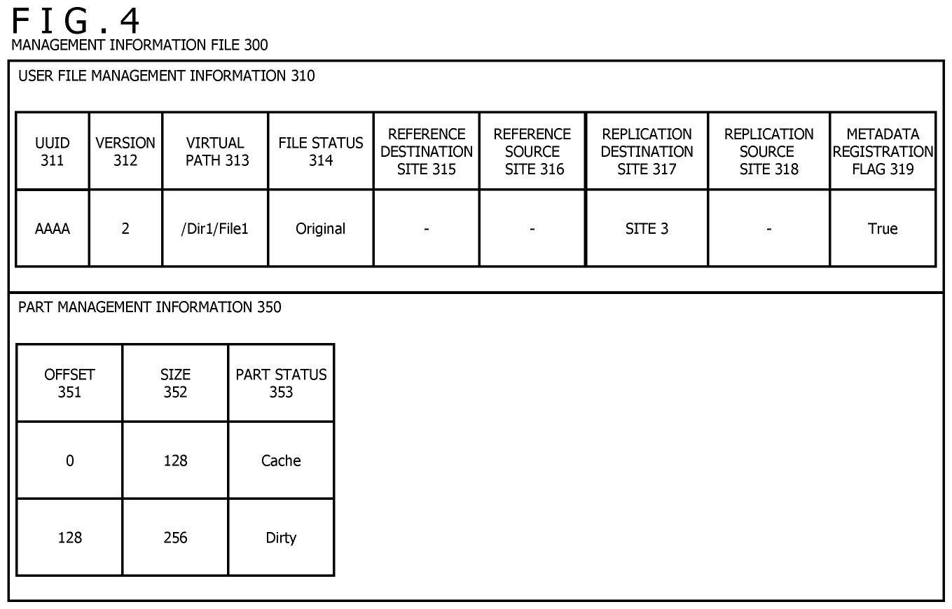

FIG. 4 is a diagram illustrating an example of the management information files 300 of the file storage system 1 according to the first embodiment.

The management information file 300 is generated for each of the user files 200. The management information file 300 includes user file management information 310 and part management information 350.

The user file management information 310 includes, as entries, a UUID 311, a version 312, a virtual path 313, a file status 314, a reference destination site 315, a reference source site 316, a replication destination site 317, a replication source site 318, and a metadata registration flag 319.

Values of the entries of the user file management information 310 presented in FIG. 4 are values of the file 200-12 (see FIG. 3), which are presented by way of example. The UUID 311 is the value of the UUID of the user file 200. The version 312 is the value of the version of the user file 200. The virtual path 313 is a file path of the user file 200 in the site (in this case, the site 1-1) in which the user file 200 is stored. The file status 314 is the status of the user file 200, and as shown in FIG. 3, the value of “original,” “stub,” “cache,” or “replica” is stored therein. The reference destination site 315 is the site name of a site in which the substantial file is stored when this user file 200 is a stub file. The reference source site 316 is the site name of a site in which a stub file of this user file 200 is stored when there is such a stub file. The replication destination site 317 is the site name (in the illustrated example, a “site 3,” which is the site name of the site in which a replicated file of the file 200-11 is stored) of a site in which a replicated file of this user file 200 is stored when there is such a replicated file. The replication source site 318 is the site name of a site in which the substantial file is stored when this user file 200 is a replicated file. The metadata registration flag 319 is a flag indicating whether or not metadata of this user file 200 has already been extracted and registered in the metadata DB 400 by the metadata extraction program 134 (“True” when the metadata has already been registered, and “False” when the metadata has not been registered).

The part management information 350 includes, as entries, an offset 351, a size 352, and a part status 353. Each entry of the part management information 350 is information indicating whether a part of the target user file 200 has a stub file or the like.

The offset 351 is the value of an offset from top data to a part that has a stub file or the like when the user file 200 has such a part. The size 352 is the size of data of the part. The part status 353 is a value indicating the status of the data. The value of “Cache,” “Dirty,” or “Stub” is stored in the part status 353. “Cache” indicates that data in the user file 200 is possessed and has already been replicated in the replication destination site. “Dirty” indicates that data in the user file 200 is possessed and has not yet been replicated in the replication destination site. “Stub” indicates that data in the user file 200 is not possessed (thus, the data needs to be acquired (recalled) from another site when an access request has been received).

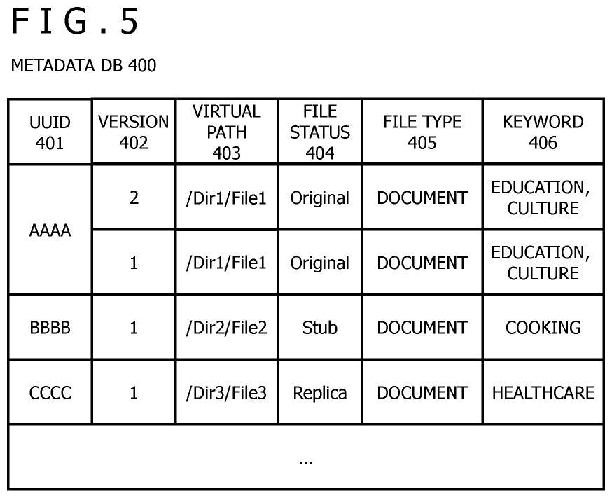

FIG. 5 is a diagram illustrating an example of the metadata DB 400 of the file storage system 1 according to the first embodiment.

The metadata DB 400 is generated for each of the sites 1-1 to 1-3, and is used for data retrieval between the sites 1-1 to 1-3 as suggested above. The metadata DB 400 includes, as entries, a UUID 401, a version 402, a virtual path 403, a file status 404, a file type 405, and a keyword 406.

Values of the entries of the metadata DB 400 presented in FIG. 5 are values of the metadata DB 400 stored in the storage device 124 of the site 1-1, which are presented by way of example. The UUID 401 is the value of the UUID of a user file 200 stored in the storage device 124 of the site. The version 402 is the value of the version of the user file 200 stored in the storage device 124 of the site. The virtual path 403 is a file path of the user file 200 stored in the storage device 124 of the site, in the site (in this case, the site 1-1) in which the user file 200 is stored. The file status 404 is the status of the user file 200 stored in the storage device 124 of the site, and as shown in FIG. 3, the value of “original,” “stub,” “cache,” or “replica” is stored therein. The file type 405 is the type of the user file 200 stored in the storage device 124 of the site, and the keyword 406 is a keyword(s) included in the user file 200 stored in the storage device 124 of the site.

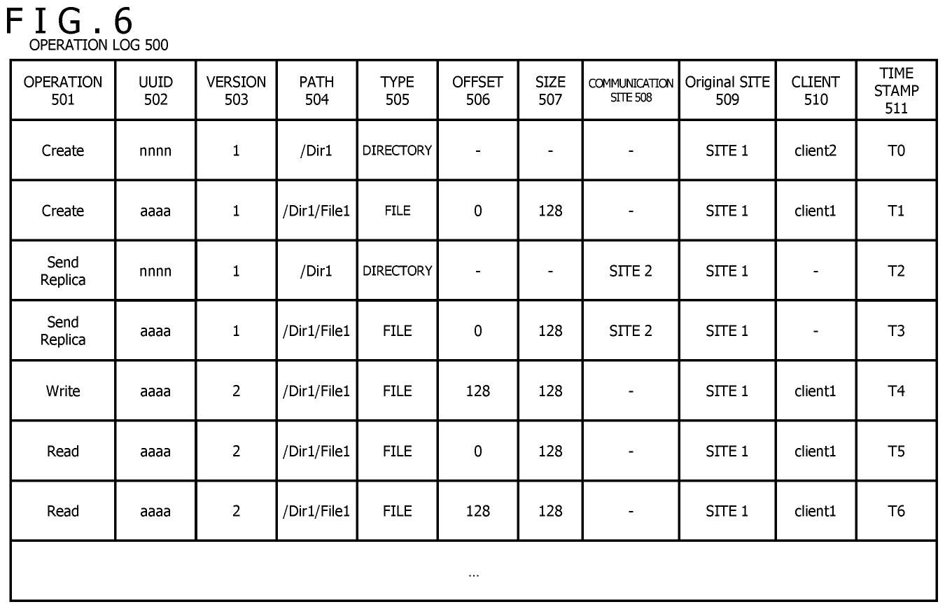

FIG. 6 is a diagram illustrating an example of the operation log 500 of the file storage system 1 according to the first embodiment.

The operation log 500 is generated for each of the sites 1-1 to 1-3, and is used to generate the learning data set 600, which will be described below. The operation log 500 is an access log (not shown) from which entries that are not necessary for generation of the learning data set 600 are eliminated. Note that different operation logs 500 may be generated for different namespaces.

The operation log 500 includes, as entries, an operation 501, a UUID 502, a version 503, a path 504, a type 505, an offset 506, a size 507, a communication site 508, an original site 509, a client 510, and a time stamp 511.

The operation 501 is the content/type of an operation performed on a user file 200/directory 250 stored in the site. The UUID 502 is the value of the UUID of the user file 200/directory 250 on which the operation has been performed. The version 503 is the value of the version of the user file 200/directory 250 on which the operation has been performed. The path 504 is a file path of the user file 200/directory 250 on which the operation has been performed, in the site in which the user file 200/directory 250 is stored. The type 505 is the type (i.e., a file 200 or a directory 250) of the user file 200/directory 250 on which the operation has been performed. The offset 506 is the value of an offset of data on which the operation has been performed, in the user file 200/directory 250 on which the operation has been performed. The size 507 is the size of the data on which the operation has been performed, in the user file 200/directory 250 on which the operation has been performed. The communication site 508 is a site with which a communication has been performed when the operation involves a communication with another site. The client 510 is information identifying the client 11 that has issued an instruction to perform the operation on the user file 200/directory 250. The time stamp 511 is a time stamp of a time at which the operation was performed.

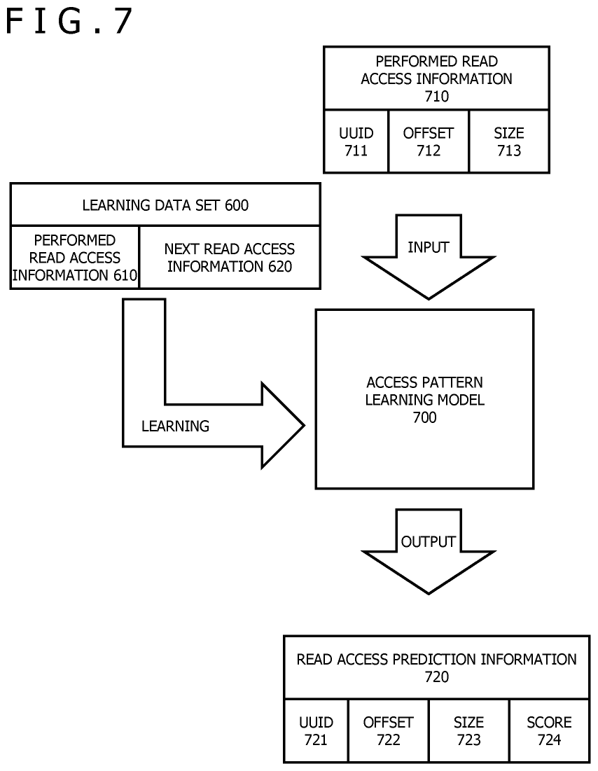

FIG. 7 is a diagram illustrating an example of the access pattern learning model 700 of the file storage system 1 according to the first embodiment.

The access pattern learning model 700 is generated for each of the sites 1-1 to 1-3, but different access pattern learning models 700 may be generated for different namespaces. The learning data set 600 and performed read access information 710 are inputted to the access pattern learning model 700, and read access prediction information 720 is outputted from the access pattern learning model 700.

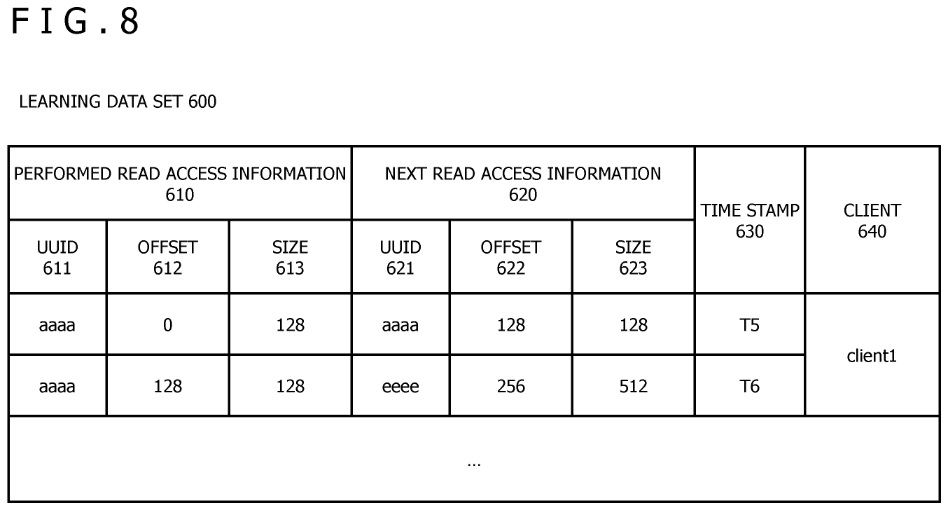

The learning data set 600 includes performed read access information 610 and next read access information 620. The performed read access information 610 is information concerning a read access (read request) made to the local site, while the next read access information 620 is information concerning a next read access made after the read access that is made to the local site and that is indicated by the performed read access information 610. The learning data set 600 will be described in detail below with reference to FIG. 8.

The performed read access information 710 is information concerning the latest read access, and has a data structure similar to that of the performed read access information 610. As a prerequisite for acquisition of prefetch hint data, which will be described below, the performed read access information 710 is inputted to the access pattern learning model 700 to obtain the read access prediction information 720 by using the access pattern learning model 700.

The performed read access information 710 includes, as entries, a UUID 711, an offset 712, and a size 713. The UUID 711 is the value of the UUID of a user file 200 to which a read access has been made. The offset 712 is the value of an offset of data to which the read access has been made, in the user file 200 to which the read access has been made. The size 713 is the size of the data to which the read access has been made.

The read access prediction information 720 is information concerning a next read access that is predicted to be made after the read access indicated by the performed read access information 710, and is an inference result (output) of the access pattern learning model 700.

The read access prediction information 720 includes, as entries, a UUID 721, an offset 722, a size 723, and a score 724. The UUID 721 is the value of the UUID of a user file 200 a read access to which has been inferred by the access pattern learning model 700. The offset 722 is the value of an offset of data to which the read access is to be made, in the user file 200 the read access to which has been inferred by the access pattern learning model 700. The size 723 is the size of the data the read access to which has been inferred by the access pattern learning model 700. The score 724 is a score indicating the reliability of the inference result obtained by the access pattern learning model 700.

Note that FIG. 7 illustrates examples of pieces of information inputted to and outputted from the access pattern learning model 700, and that the input to and the output from the access pattern learning model 700 are not limited to the examples illustrated in the figure. Various modifications are possible. For example, a plurality of immediately succeeding read accesses may be predicted on the basis of information concerning a plurality of latest read accesses, or a file path and/or information of the UUID of a parent directory may be inputted to and outputted from the access pattern learning model 700. In addition, the specific structure of the access pattern learning model 700 is not limited to particular structures, and a known learning model used in what is called machine learning (including deep learning) is suitably applicable.

FIG. 8 is a diagram illustrating an example of the learning data set 600 of the file storage system 1 according to the first embodiment.

The learning data set 600 is generated for each of the sites 1-1 to 1-3, but different learning data sets 600 may be generated for different namespaces. The learning data set 600 includes the performed read access information 610 and the next read access information 620 as described above, and further includes a time stamp 630 and a client 640.

Each of the performed read access information 610 and the next read access information 620 includes, as entries, a UUID 611 or 621, an offset 612 or 622, and a size 613 or 623. Each of the UUIDs 611 and 621 is the value of the UUID of a user file 200 to which a read access has been made. Each of the offsets 612 and 622 is the value of an offset of data to which the read access has been made, in the user file 200 to which the read access has been made. Each of the sizes 613 and 623 is the size of the data to which the read access has been made.

The time stamp 630 is a time stamp of a time of the read access indicated by the performed read access information 610, and the client 640 is information identifying the client 11 that has made the read access. Here, the learning data set 600 has the client 640 as an entry because the access pattern learning model 700 learns the order of accesses separately with respect to each client 11.

Note that FIG. 8 illustrates an example of the learning data set 600, and that the details of the learning data set 600 are not limited to the example illustrated in FIG. 8. No particular limitations are placed on the learning data set 600 as long as an appropriate inference result can be obtained by the access pattern learning model 700, and various structures of the learning data set 600 are possible. For example, a file path and/or information of the UUID of a parent directory may be learned, and an operation other than the read access may be learned.

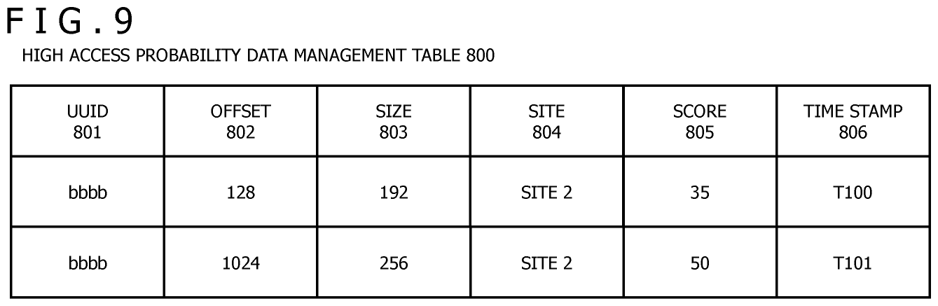

FIG. 9 is a diagram illustrating an example of the high access probability data management table 800 of the file storage system 1 according to the first embodiment.

The high access probability data management table 800, an example of which is illustrated in FIG. 9, is generated for each of the sites 1-1 to 1-3. The high access probability data management table 800 is a table for managing prefetch hint data (which will be described in detail below) reported from another site.

The high access probability data management table 800 includes, as entries, a UUID 801, an offset 802, a size 803, a site 804, a score 805, and a time stamp 806. The UUID 801 is the value of the UUID of a user file 200 a next read access to which is predicted to be made after the read access. The offset 802 is the value of an offset of data in the user file 200 a read access to which is predicted to be made. The size 803 is the size of the data a read access to which is predicted to be made. The site 804 is a site in which the user file 200 a read access to which is predicted to be made is located. The score 805 is a value identical to that of the score 724 of the read access prediction information 720. The time stamp 806 is a time stamp of a time of reporting of the prefetch hint data.

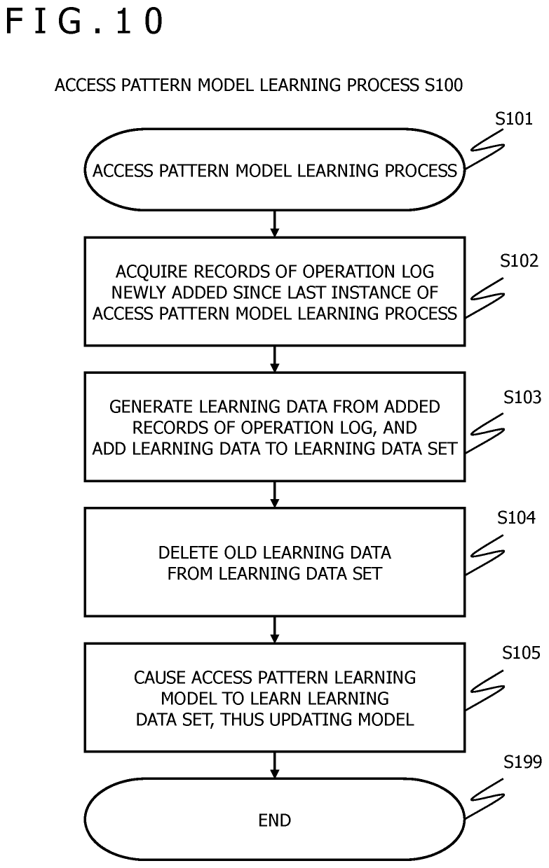

Next, operations of the file storage system 1 according to the present embodiment will be described below with reference to flowcharts of FIGS. 10, 11, 12, 14, 15, 16, and 17.

FIG. 10 is a flowchart for explaining an example of an access pattern model learning process of the file storage system 1 according to the first embodiment.

An access pattern model learning process S100 illustrated in the flowchart of FIG. 10 is performed, for example, periodically or at a time when a predetermined number of records of the operation log 500 that remain to be handled have been accumulated.

First, once the access pattern model learning process is started (step S101), the access pattern learning program 137 acquires records of the operation log 500 that have been newly added since the last instance of the access pattern model learning process (step S102).

Next, the access pattern learning program 137 generates learning data from the newly added records of the operation log 500 acquired in step S102, and adds the generated learning data to the learning data set 600 (step S103).

Further, the access pattern learning program 137 deletes old learning data from the learning data set 600 (step S104), and causes the access pattern learning model 700 to learn the learning data set 600, thus updating the access pattern learning model 700 (step S105). No particular limitations are placed on the method of the learning in step S105, and examples of applicable methods include a method in which the newness of learning data is determined from the time stamp 630 of the learning data set 600 to assign a weight thereto for the learning, a method in which the learning data set 600 is learned as time-series data, and so on.

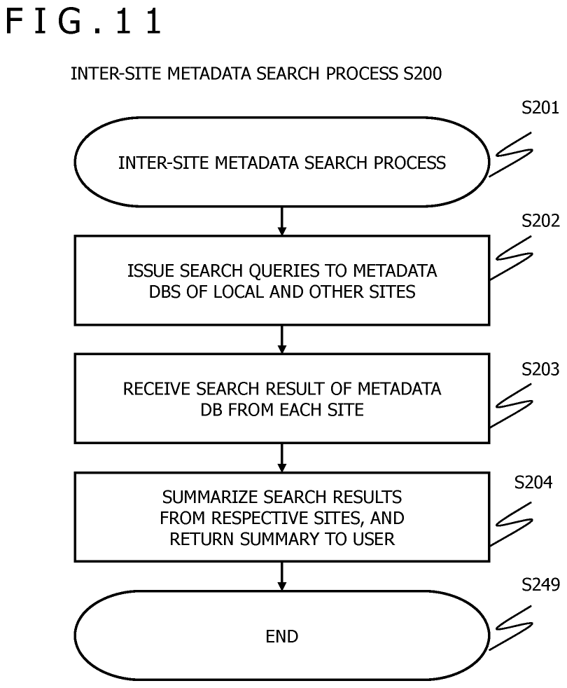

FIG. 11 is a flowchart for explaining an example of an inter-site metadata search process of the file storage system 1 according to the first embodiment.

An inter-site metadata search process S200 illustrated in the flowchart of FIG. 11 is performed when a file search request has been received from any client 11.

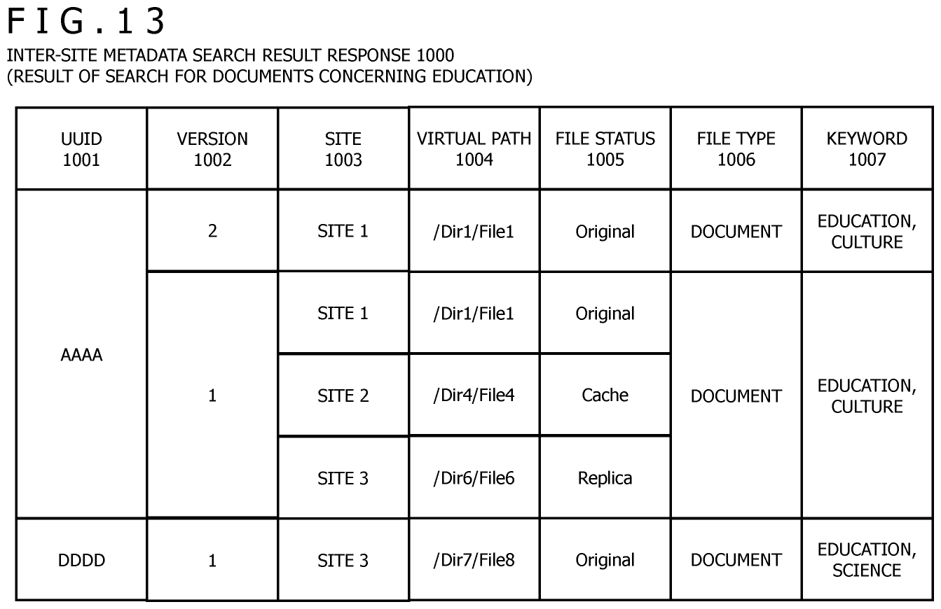

First, once the file search request is received from the client 11 (step S201), the metadata DB program 133 issues search queries corresponding to the file search request to the metadata DBs 400 of the local and other sites (step S202). Next, the metadata DB program 133 receives a search result of the metadata DB 400, which is a response to the search query issued in step S202, from each of the sites (step S203). Then, the metadata DB program 133 summarizes the search results received in step S203, and returns the resulting summary to the client 11 that has made the file search request (step S204). Details of the summarized search results will be described below with reference to FIG. 13.

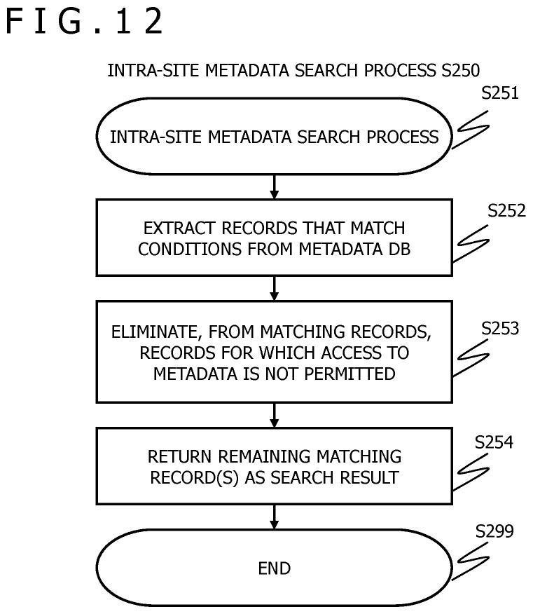

FIG. 12 is a flowchart for explaining an example of an intra-site metadata search process of the file storage system 1 according to the first embodiment.

An intra-site metadata search process S250 illustrated in the flowchart of FIG. 12 is performed when the search query shown in step S202 of the flowchart of FIG. 11 has been received from another site.

First, once the search query is received from another site (step S251), the metadata DB program 133 extracts a record(s) that matches a condition(s), from the metadata DB 400 (step S252). Next, the metadata DB program 133 eliminates, from the record(s) extracted in step S252, a record(s) for which access to metadata is not permitted (step S253). Then, the metadata DB program 133 returns, as a search result, the record(s) that remains after the elimination in step S253 to the site that has issued the search query (step S254).

FIG. 13 is a diagram illustrating an example of an inter-site metadata search result response of the file storage system 1 according to the first embodiment. The example of the inter-site metadata search result response illustrated in FIG. 13 is an example of the response returned from the metadata DB program 133 to the client 11 that has made the file search request in step S204 in FIG. 11. The example illustrated in FIG. 13 assumes that the client 11 has made a request to search for documents concerning “education.”

The inter-site metadata search result response 1000 includes, as entries, a UUID 1001, a version 1002, a site 1003, a virtual path 1004, a file status 1005, a file type 1006, and a keyword 1007. The inter-site metadata search result response 1000 is similar to the metadata DB 400 illustrated in FIG. 5, except that the site 1003 is added as an entry.

The UUID 1001 is the value of the UUID of a user file 200 that matches a search request. The version 1002 is the value of the version of the user file 200 that matches the search request. The site 1003 is the site name of a site in which the user file 200 that matches the search request is stored. The virtual path 1004 is a file path of the user file 200 that matches the search request, in the site in which the user file 200 is stored. The file status 1005 is the status of the user file 200 that matches the search request, and the value of “original,” “stub,” “cache,” or “replica” is stored therein. The file type 1006 is the type of the user file 200 that matches the search request, and the keyword 1007 is a keyword(s) included in the user file 200 that matches the search request.

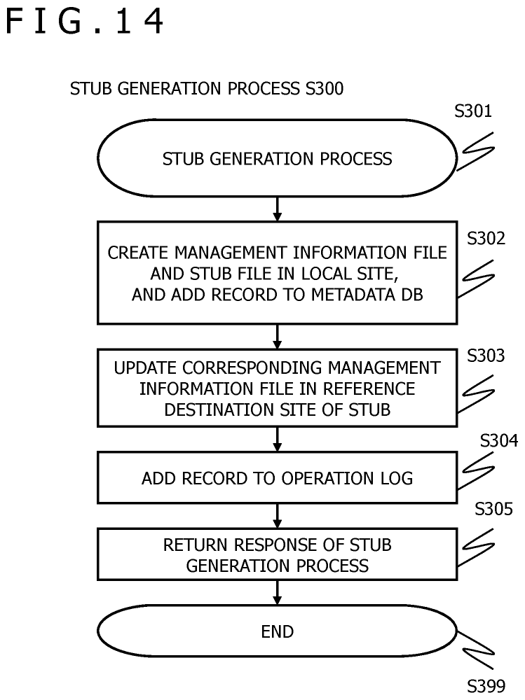

FIG. 14 is a flowchart for explaining an example of a stub generation process of the file storage system 1 according to the first embodiment.

A stub generation process S300 illustrated in the flowchart of FIG. 14 is performed when a stub generation request has been received from a client 11 that has received a metadata search result. Note that no particular limitations are placed on a trigger for the stub generation process S300, and that the stub generation process S300 is applicable also to methods of sharing data between sites, other than the method of sharing data between sites by using the metadata DBs 400.

First, once the stub generation request is received from the client 11 (step S301), the file/object virtualization program 131 creates a management information file 300 and a stub file in the local site, and adds a corresponding record to the metadata DB 400 (step S302). Next, the file/object virtualization program 131 updates the corresponding management information file 300 in the reference destination site of the stub file, i.e., in the site in which the file for which the stub file has been created is stored (step S303). That is, the file/object virtualization program 131 in the reference destination site adds a record of the reference source site 316 to the management information file 300. Further, the file/object virtualization program 131 adds a corresponding record to the operation log 500 (step S304), and returns a response of the stub generation process to the client 11 that has made the stub generation request (step S305).

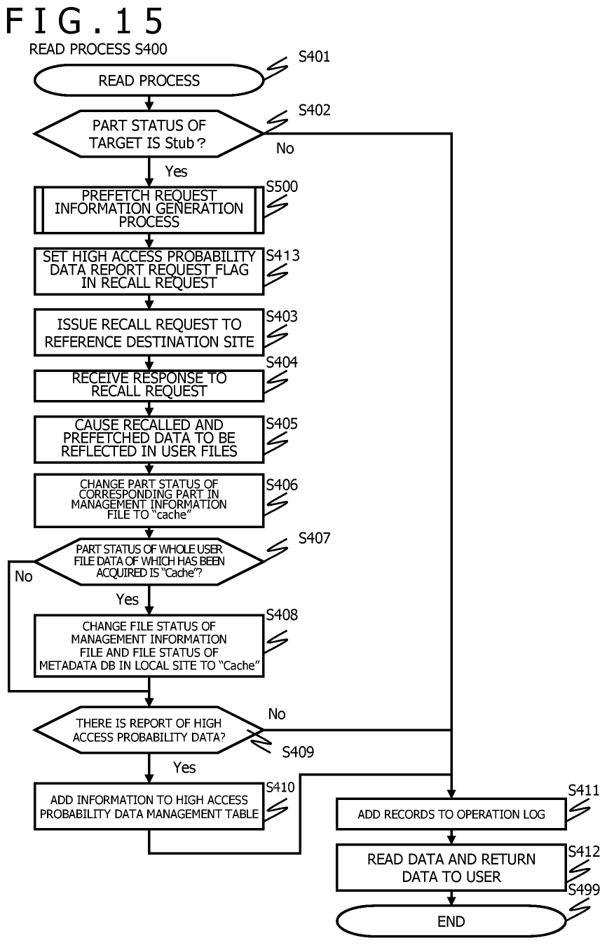

FIG. 15 is a flowchart for explaining an example of a read process of the file storage system 1 according to the first embodiment.

A read process S400 illustrated in the flowchart of FIG. 15 is performed when a read request has been received from any client 11.

First, once the read request is received from the client 11 (step S401), the file/object virtualization program 131 determines whether or not the part status of data to be read by the read request is “Stub,” by referring to the part management information 350 of the management information file 300 (step S402). Then, if it is determined that the part status of the data is “Stub” (YES in step S402), meaning that (a part of) the target data has not been cached in the local site, an operation for making a request to recall the target data to another site is performed. Specifically, operations of step S500, step S413, and subsequent steps are performed. On the other hand, if it is determined that the part status of the data is not “Stub” (NO in step S402), meaning that the target data has been cached in the local site, the program proceeds to step S411.

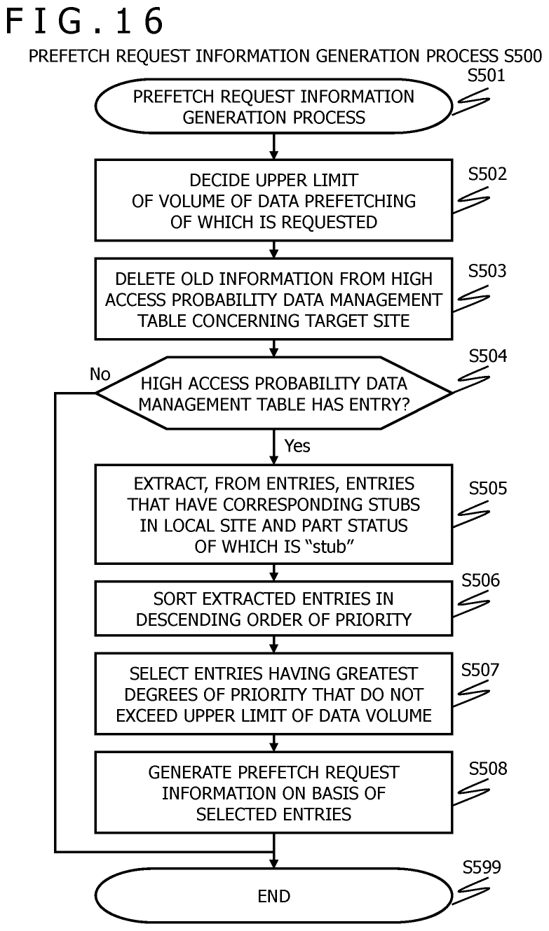

In step S500, the file/object virtualization program 131 performs a prefetch request information generation process. Details of the prefetch request information generation process will be described below with reference to FIG. 16. The prefetch request information generation process is a process for making a request to acquire additional data if there is data to be prefetched at the time of recalling the data.

Next, the file/object virtualization program 131 sets a high access probability data report request flag in the recall request to the reference destination site of the data (step S413). In the present embodiment, the high access probability data report request flag is a prefetch hint data request flag.

Further, the file/object virtualization program 131 issues the recall request to the reference destination site of the data (step S403), and receives a response to this recall request from the reference destination site of the data (step S404).

Then, the file/object virtualization program 131 causes the recalled and prefetched data to be reflected in the user file(s) 200 on the basis of the response received in step S404 (step S405), and changes the part status 353 of the corresponding part in the management information file 300 to “cache” (step S406).

Next, the file/object virtualization program 131 refers to the part management information 350 of the management information file 300, and determines whether or not the part status of the whole user file 200 data of which has been acquired from the reference destination site is “Cache” (step S407). Then, if it is determined that the part status of the whole user file 200 is “Cache” (YES in step S407), the program proceeds to step S408, whereas if it is determined that the part status of a part of the user file 200 is not “Cache” (NO in step S407), the program proceeds to step S409.

In step S408, the file/object virtualization program 131 changes the file status 314 of the management information file 300 and the file status 404 of the metadata DB 400 in the local site to “Cache.”

Next, the file/object virtualization program 131 determines whether or not the response to the recall request received in step S404 includes a report of high access probability data (step S409). The determination in step S409 is a determination as to whether or not the response to the recall request includes prefetch hint data. Then, if it is determined that the response to the recall request includes a report of high access probability data (YES in step S409), the file/object virtualization program 131 adds this high access probability data to the high access probability data management table 800 (step S410), whereas if it is determined that the response to the recall request does not include a report of high access probability data (NO in step S409), the program proceeds to step S411.

The file/object virtualization program 131 adds records of the series of operations to the operation log 500 (step S411), and reads the data to be read by the read request and returns the data to the client 11 (step S412).

FIG. 16 is a flowchart for explaining an example of the prefetch request information generation process of the file storage system 1 according to the first embodiment.

The prefetch request information generation process S500 illustrated in the flowchart of FIG. 16 is performed when called in the read process S400 illustrated in FIG. 15.

First, once the prefetch request information generation process S500 is called in the read process S400 illustrated in FIG. 15 (step S501), the file/object virtualization program 131 decides an upper limit of the volume of data prefetching of which is requested from another site (step S502). Any desirable method of deciding the upper limit of the data volume can be adopted, and examples of such methods include a method of deciding the upper limit on the basis of the proportion of storage capacity that is currently available, an upper limit of data volume per prefetch, and so on.

Next, the file/object virtualization program 131 deletes old information from the high access probability data management table 800 concerning the site to which the read request is made (step S503). A determination as to whether or not information is old can be made by, for example, setting a predetermined threshold value in advance.

Next, the file/object virtualization program 131 determines whether or not the high access probability data management table 800 has an entry (step S504). Then, if it is determined that the high access probability data management table 800 has an entry (YES in step S504), the program proceeds to step S505, whereas if it is determined that the high access probability data management table 800 has no entry (NO in step S504), the procedure illustrated in FIG. 16 is ended.

In step S505, the file/object virtualization program 131 extracts, from entries of the high access probability data management table 800, entries that have corresponding stub files in the local site and the part status 353 of which is “Stub,” by referring to the management information file(s) 300.

Next, the file/object virtualization program 131 sorts the entries extracted in step S505 in descending order of priority (step S506). The degree of priority may be decided on the basis of information of the score 805 and the time stamp 806 of the high access probability data management table 800. Further, the file/object virtualization program 131 selects, from the entries sorted in step S506, entries having the greatest degrees of priority that do not exceed the upper limit of the data volume determined in step S502 (step S507). Then, the file/object virtualization program 131 generates prefetch request information on the basis of the entries selected in step S507 (step S508).

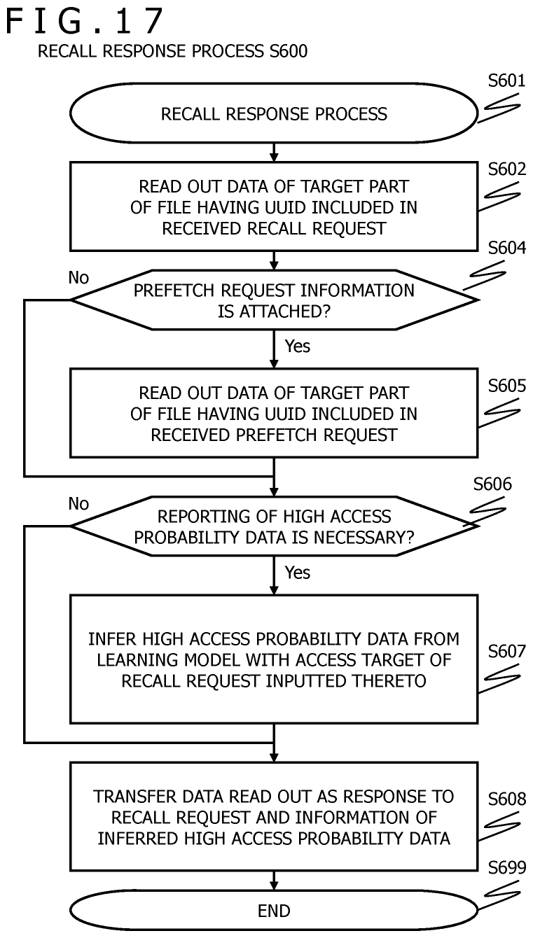

FIG. 17 is a flowchart for explaining an example of a recall response process of the file storage system 1 according to the first embodiment.

A recall response process S600 illustrated in the flowchart of FIG. 17 is performed when a recall request has been received in, for example, step S403 in the flowchart of FIG. 15.

First, once a recall request is received from another site (step S601), the file/object virtualization program 131 reads out data of a target part of the user file 200 having the UUID included in the recall request (step S602).

Next, the file/object virtualization program 131 determines whether or not the recall request has prefetch request information attached thereto (step S604). Then, if it is determined that prefetch request information is attached thereto (YES in step S604), the file/object virtualization program 131 reads out data of a target part of the user file 200 having the UUID included in the prefetch request (step S605).

On the other hand, if it is determined that no prefetch request information is attached thereto (NO in step S604), or after step S605 is performed, the file/object virtualization program 131 determines whether or not the high access probability data report request flag is included in the recall request, i.e., whether or not reporting of high access probability data to the site that has made the recall request is necessary (step S606). Then, if it is determined that reporting of the high access probability data is necessary (YES in step S606), the file/object virtualization program 131 inputs the data to be recalled by the recall request (i.e., data to be accessed) into the access pattern learning model 700, and acquires the high access probability data as an inference result (step S607). This high access probability data corresponds to the prefetch hint data.

On the other hand, if it is determined that reporting of the high access probability data is not necessary (NO in step S606), or after step S607 is performed, the file/object virtualization program 131 transfers, to the site that has made the recall request, the data read out as a response to the recall request and, in the case where the high access probability data report request flag is included in the recall request, information of the high access probability data obtained by inference in step S607 (step S608).

Thus, according to the present embodiment, prefetch hint data concerning data in another site is obtained on the basis of access pattern information (on the basis of an output from the access pattern learning model 700), and this enables prefetching of data generated in the other site. Moreover, the access pattern learning model 700 learns the offset and size of access target data as well, and the prefetch hint data outputted from the access pattern learning model 700 can include the offset and size, enabling prefetching of part data of the user file 200.

### Second Embodiment

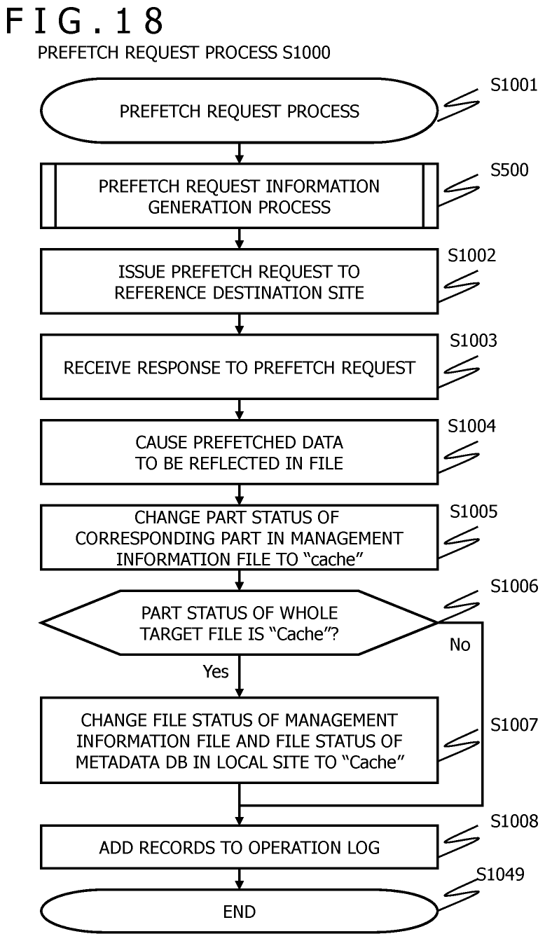

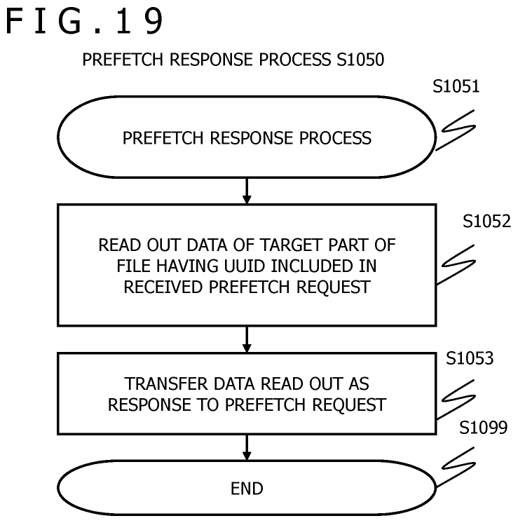

Hereinafter, a file storage system 1 according to a second embodiment of the present invention will be described with reference to flowcharts of FIGS. 18 and 19. File storage systems 1 according to embodiments of the present invention described below have substantially the same features, and accordingly, description of common features will be omitted as appropriate, and the following description will be provided with focus on differences in operation.

In the file storage system 1 according to the above-described first embodiment, the prefetch request process is performed when a read request has been made (see FIG. 15). On the other hand, in the file storage system 1 according to the present embodiment, a prefetch request process S1000 as illustrated in FIG. 18 is performed independently of a read request and asynchronously to a read request, for example, periodically or at a time when a predetermined amount of prefetch hint data that remains to be handled has been accumulated.

The flowchart of the prefetch request process illustrated in FIG. 18 is similar to the flowchart of the read process S400 illustrated in FIG. 15, and therefore, detailed description of processes that are substantially equivalent to those in FIG. 15 will be omitted, and the equivalents in FIG. 15 will be referred to. Once the prefetch request process is called (step S1001), the file/object virtualization program 131 performs the prefetch request information generation process (step S500).

Next, the file/object virtualization program 131 issues the prefetch request to the reference destination site (step S1002). Then, once a response to the prefetch request is received from the reference destination site (step S1003), the file/object virtualization program 131 causes the prefetched data to be reflected in the user file(s) 200 (step S1004).

The following processes of steps S1006, S1007, and S1008 are similar to the processes of steps S407, S408, and S411, respectively, in FIG. 15.

FIG. 19 is a flowchart for explaining an example of a prefetch response process of the file storage system 1 according to the second embodiment.

A prefetch response process S1050 illustrated in the flowchart of FIG. 19 is performed when the prefetch request has been received in step S1002 in the flowchart of FIG. 18.

The flowchart of the prefetch response process illustrated in FIG. 19 is similar to part of the flowchart of the recall response process S600 illustrated in FIG. 17, and therefore, detailed description of processes that are substantially equivalent to those in FIG. 17 will be omitted, and the equivalents in FIG. 17 will be referred to.

Once the prefetch request is received (step S1051), the file/object virtualization program 131 performs a process similar to that of step S605 in FIG. 17 (step S1052). Then, the file/object virtualization program 131 transfers, to the site that has issued the prefetch request, the data read out as a response to the prefetch request (step S1053).

Accordingly, the present embodiment is able to achieve beneficial effects similar to those of the first embodiment.

### Third Embodiment

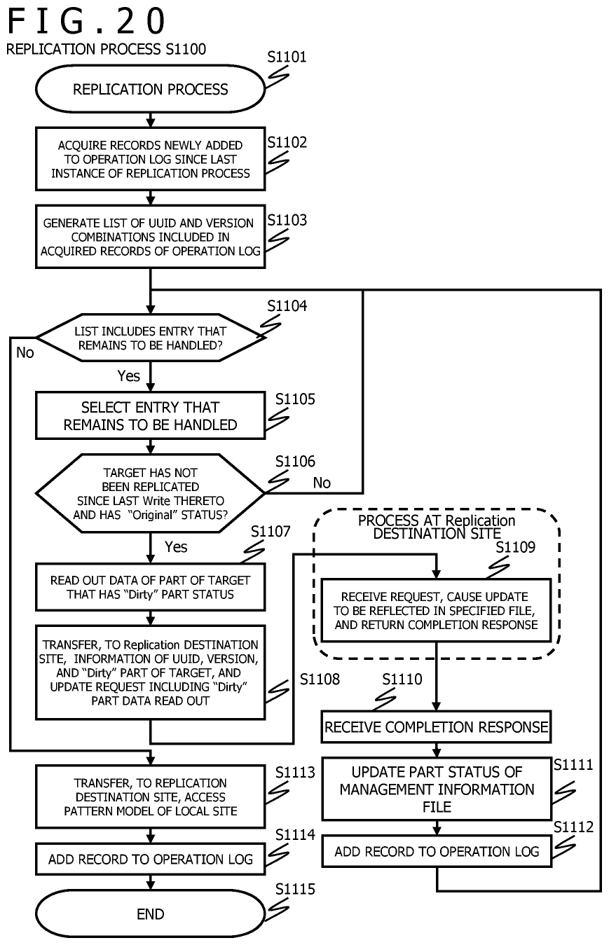

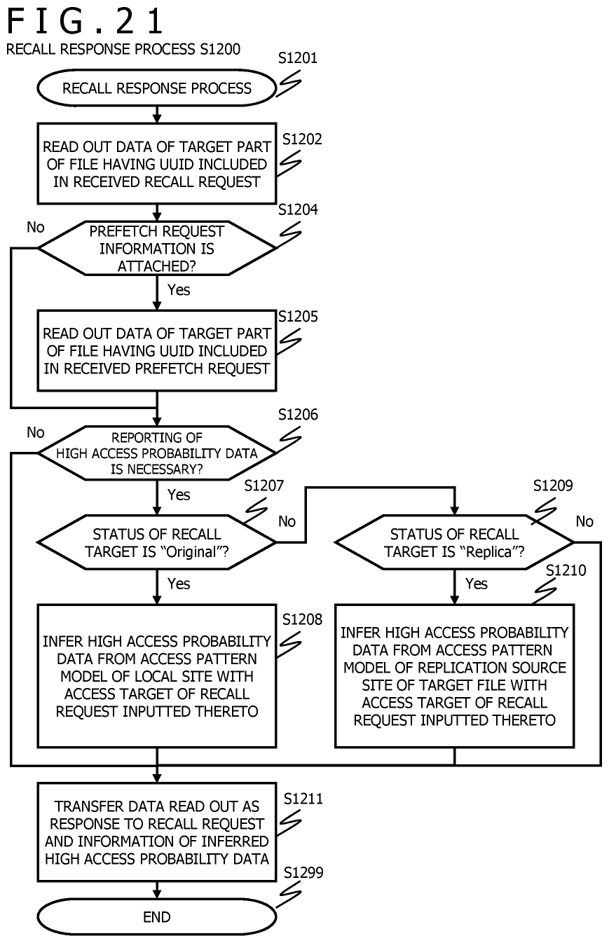

Next, a file storage system 1 according to a third embodiment of the present invention will be described below with reference to flowcharts of FIGS. 20 and 21. In the file storage system 1 according to the present embodiment, access pattern information (i.e., the access pattern learning model 700) of the local site is sent to a replication destination of a file.

FIG. 20 is a flowchart for explaining an example of a replication process of the file storage system 1 according to the third embodiment.

A replication process S1100 illustrated in the flowchart of FIG. 20 is performed, for example, periodically or at a time when a predetermined number of records of the operation log 500 have been accumulated.

First, once an instruction to perform the replication process is issued (step S1101), the file/object virtualization program 131 acquires a record(s) that has been newly added to the operation log 500 since the last instance of the replication process (step S1102), and generates a list of UUIDs 502 and versions 503 included in the acquired record(s) of the operation log 500 (step S1103).

Then, the file/object virtualization program 131 determines whether or not the list generated in step S1103 includes an entry that remains to be handled (step S1104). Then, if it is determined that the list includes an entry that remains to be handled (YES in step S1104), the program proceeds to step S1105, whereas if it is determined that the list does not include an entry that remains to be handled (i.e., that all entries have been handled) (NO in step S1104), the program proceeds to step S1113. The following processes of steps S1104 to S1112 correspond to a replication process for a user file 200.

In step S1105, the file/object virtualization program 131 selects an (optional) entry that remains to be handled, from the list generated in step S1103. Next, the file/object virtualization program 131 determines whether or not a target file corresponding to the entry selected in step S1105 has not been replicated since the last (i.e., the latest) write to the target file and has the “original” status (step S1106). The determination in step S1106 is a determination as to whether or not an update of the target file has been performed. If an affirmative determination is made (YES in step S1106), the program proceeds to step S1107, whereas if a negative determination is made (NO in step S1106), the program returns to step S1104.

In step S1107, the file/object virtualization program 131 reads out data of a part of the target file that has the “Dirty” part status. Then, the file/object virtualization program 131 transfers, to the replication destination site, information of the UUID 502, the version 503, and the “Dirty” part data of the target file, and an update request including the “Dirty” part data (step S1108).

The file/object virtualization program 131 of the replication destination site receives the update request, causes an update indicated by the update request to be reflected in the corresponding file, and returns a completion response to the site that has transferred the update request (step S1109).

The file/object virtualization program 131 of the site that has transferred the update request receives the completion response from the replication destination site (step S1110), updates the part status 353 of the management information file 300 (step S1111), and adds a corresponding record to the operation log 500 (step S1112). Thereafter, the program proceeds to step S1104, and continues the procedure.

Meanwhile, in step S1113 in which the replication process has already been completed, the file/object virtualization program 131 transfers, to the replication destination site, access pattern model (i.e., the access pattern learning model 700) of the local site, and adds a corresponding record to the operation log 500 (step S1114).

FIG. 21 is a flowchart for explaining an example of a recall response process of the file storage system 1 according to the third embodiment.

The flowchart of the recall response process illustrated in FIG. 21 is similar to the flowchart of the recall response process S600 illustrated in FIG. 17, and therefore, detailed description of processes that are substantially equivalent to those in FIG. 17 will be omitted, and the equivalents in FIG. 17 will be referred to.

A recall response process S1200 illustrated in the flowchart of FIG. 21 is performed when a recall request has been received in, for example, step S403 in the flowchart of FIG. 15.

Processes of steps S1202, S1204, S1205, and S1206 are similar to the processes of steps S602, S604, S605, and S606, respectively, in FIG. 17.

Next, the file/object virtualization program 131 determines whether or not the high access probability data report request flag is included in the recall request, i.e., whether or not reporting of high access probability data to the site that has sent the recall request is necessary (step S1206). If it is determined that reporting of the high access probability data is necessary (YES in step S1206), the program proceeds to step S1207, whereas if it is determined that reporting of the high access probability data is not necessary (NO in step S1206), the program proceeds to step S1211.

In step S1207, the file/object virtualization program 131 determines whether or not the status of the file to be recalled is “original.” Then, if it is determined that the file status is “original” (YES in step S1207), the program proceeds to step S1208, whereas if it is determined that the file status is not “original” (NO in step S1207), the program proceeds to step S1209.

In step S1208, data of the access target of the recall request is inputted to the access pattern learning model 700 of the local site to obtain high access probability data as an inference result.

Meanwhile, in step S1209, the file/object virtualization program 131 determines whether or not the status of the file to be recalled is “Replica.” Then, if it is determined that the file status is “Replica” (YES in step S1209), the program proceeds to step S1210, whereas if it is determined that the file status is not “Replica” (NO in step S1209), the program proceeds to step S1211.

In step S1210, the data of the access target of the recall request is inputted to the access pattern learning model 700 (sent in step S1113 in FIG. 20) from the replication source site of the target file to obtain high access probability data as an inference result.

Then, in step S1211, a process similar to that of step S608 in FIG. 17 is performed.

Accordingly, the present embodiment is also able to achieve beneficial effects similar to those of the first embodiment.

### Fourth Embodiment

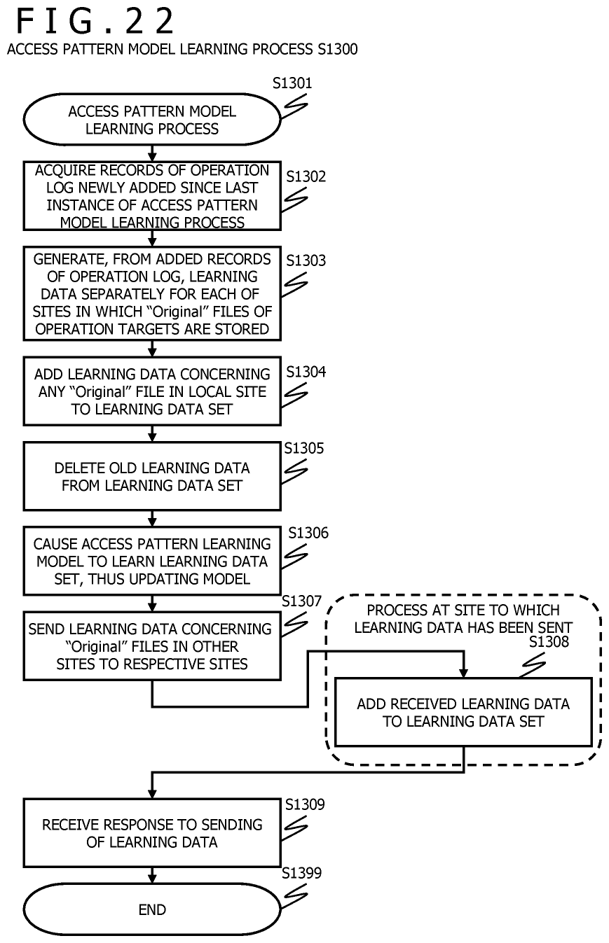

Next, a file storage system 1 according to a fourth embodiment of the present invention will be described below with reference to a flowchart of FIG. 22. In the file storage system 1 according to the present embodiment, learning data sets 600 for other sites are generated and are transferred to the other sites.

FIG. 22 is a flowchart for explaining an example of an access pattern model learning process of the file storage system 1 according to the fourth embodiment.

The flowchart of the access pattern model learning process illustrated in FIG. 22 is similar to the flowchart of the access pattern model learning process S100 illustrated in FIG. 10, and therefore, detailed description of processes that are substantially equivalent to those in FIG. 10 will be omitted, and the equivalents in FIG. 10 will be referred to.

An access pattern model learning process S1300 illustrated in the flowchart of FIG. 22 is performed, for example, periodically or at a time when a predetermined number of records of the operation log 500 that remain to be handled have been accumulated.

A process of step S1302 is similar to that of step S102 in the flowchart of FIG. 10.

Next, the file/object virtualization program 131 generates, from the newly added records of the operation log 500 acquired in step S1302, learning data separately for each of the sites in which the “Original” files corresponding to the files on which operations have been performed are stored (step S1303). Further, the file/object virtualization program 131 adds learning data concerning any “Original” file in the local site to the learning data set 600 (step S1304).

Processes of steps S1305 and S1306 are similar to those of steps S104 and S105, respectively, in the flowchart of FIG. 10.

Thereafter, the file/object virtualization program 131 sends the learning data concerning the “Original” files in other sites to the respective sites (step S1307), and each of the other sites receives the learning data and adds the received learning data to the learning data set 600 (step S1308). Then, the file/object virtualization program 131 receives a response to the sending of the learning data (step S1309).

Accordingly, the present embodiment is also able to achieve beneficial effects similar to those of the first embodiment.

### Fifth Embodiment

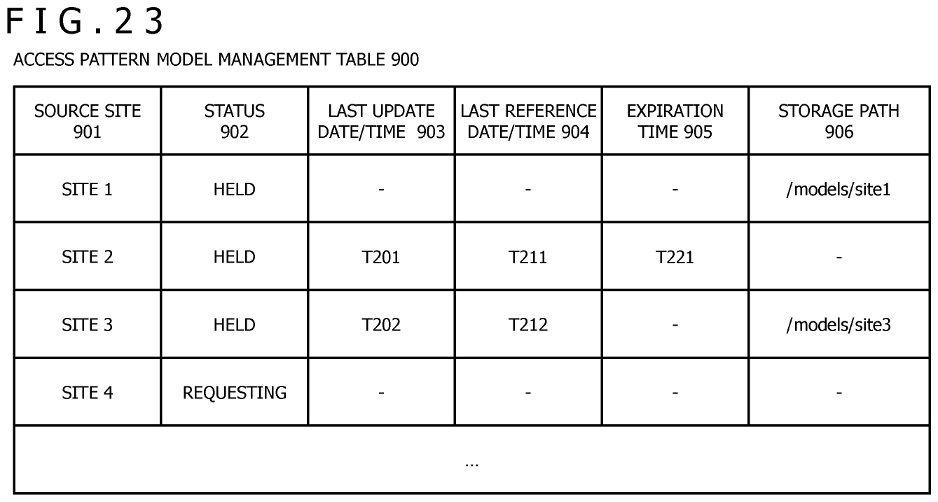

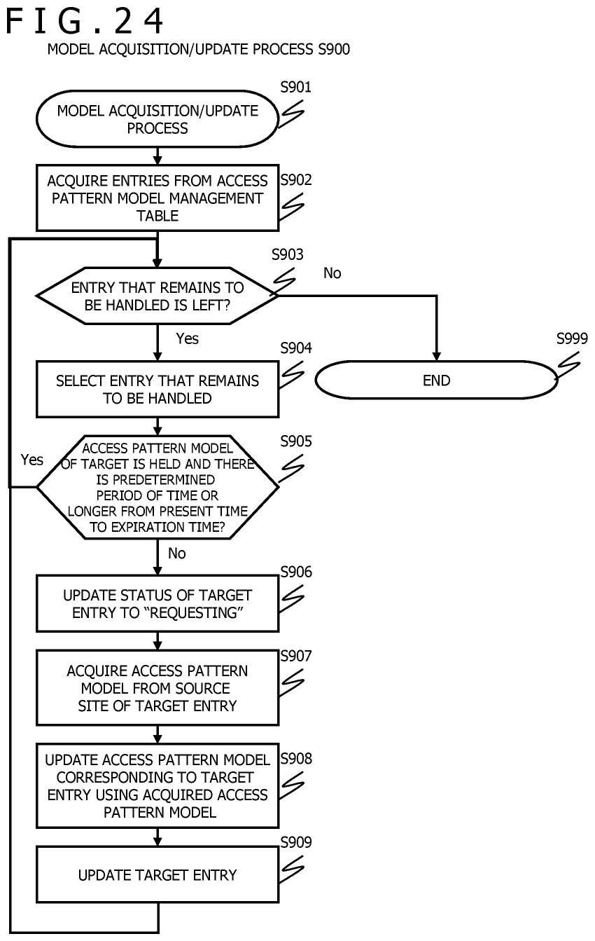

Next, a file storage system 1 according to a fifth embodiment of the present invention will be described below with reference to FIG. 23 and flowcharts of FIGS. 24, 25, and 26. In the file storage system 1 according to the present embodiment, the access pattern learning model 700 is received as prefetch hint data. In addition, the access pattern learning model 700, which is the prefetch hint data, is received when a stub file is generated.

FIG. 23 is a diagram illustrating an example of an access pattern model management table 900 of the file storage system 1 according to the fifth embodiment.

The access pattern model management table 900 is generated separately for each of the sites 1-1 to 1-3, and is a table for managing access pattern information (i.e., the access pattern learning models 700) acquired from other sites. The access pattern model management table 900 includes, as entries, a source site 901, a status 902, a last update date/time 903, a last reference date/time 904, an expiration time 905, and a storage path 906.

The source site 901 is the site name of a source of the acquired access pattern learning model 700. The status 902 is the status of acquisition of the access pattern learning model 700 (e.g., whether the access pattern learning model 700 is held in the local site or is being requested, for example). The last update date/time 903 is the last update date/time of the access pattern learning model 700. The last reference date/time 904 is the last reference date/time of the access pattern learning model 700. The expiration time 905 is a reference value for determining that the access pattern learning model 700 is so old that the access pattern learning model 700 needs to be updated. Note that the access pattern learning model 700 generated and held in the local site does not have the expiration time. Also, note that the expiration time 905 may not be set for snapshot data or the like. The storage path 906 is a path in the local site in which the access pattern learning model 700 is stored.

FIG. 24 is a flowchart for explaining an example of a model acquisition/update process of the file storage system 1 according to the fifth embodiment.

A model acquisition/update process S900 illustrated in the flowchart of FIG. 24 is regularly performed at predetermined intervals, or is performed, for example, at a time when expiration of the access pattern learning model 700 has been recognized at the time of a read process, or at a time when a lack of the access pattern learning model 700 of the reference destination site has been recognized at the time of a stub generation process or a read process.

Once an instruction to start the model acquisition/update process is issued (step S901), the file/object virtualization program 131 first acquires entries from the access pattern model management table 900 (step S902).

Next, the file/object virtualization program 131 determines whether or not the entries acquired in step S902 include an entry that remains to be handled (step S903). Then, if it is determined that the entries include an entry that remains to be handled (YES in step S903), the program proceeds to step S904, whereas if it is determined that the entries do not include an entry that remains to be handled (i.e., all the entries have already been handled) (NO in step S903), the procedure illustrated in the flowchart of FIG. 24 is ended (step S999).

In step S904, an (optional) entry that remains to be handled is selected, and then, the file/object virtualization program 131 refers to the status 902 and the expiration time 905 of the entry and determines whether or not the access pattern learning model 700 corresponding to the entry is held in the local site and there is a predetermined period of time or longer from the present time to the expiration time (step S905). Then, if an affirmative determination is made, the program returns to step S903 and continues the procedure, whereas if a negative determination is made, the program proceeds to step S906.

In step S906, the status 902 of the target entry is updated to “requesting.” Next, the file/object virtualization program 131 refers to the source site 901 of the target entry, and acquires the access pattern learning model 700 from the site indicated in the source site 901 (step S907).

Further, the file/object virtualization program 131 updates the access pattern learning model 700 corresponding to the target entry by using the access pattern learning model 700 acquired in step S907 (step S908), and updates the target entry (step S909). Thereafter, the program returns to step S903 and continues the procedure.

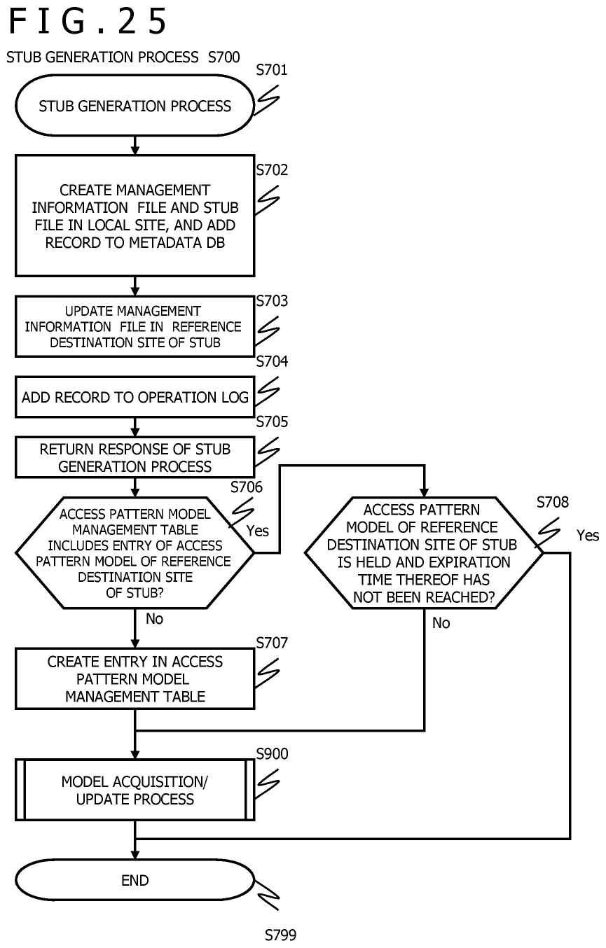

FIG. 25 is a flowchart for explaining an example of a stub generation process of the file storage system 1 according to the fifth embodiment.

The flowchart of a stub generation process S700 illustrated in FIG. 25 is similar to the flowchart of the stub generation process S300 illustrated in FIG. 14, and therefore, detailed description of processes that are substantially equivalent to those in FIG. 14 will be omitted, and the equivalents in FIG. 14 will be referred to.

As is the case with the stub generation process S300 illustrated in the flowchart of FIG. 14, the stub generation process S700 illustrated in the flowchart of FIG. 25 is performed when a stub generation request has been received from a client 11 that has received a metadata search result.

First, once the stub generation request is received from the client 11 (step S701), the file/object virtualization program 131 performs processes of steps S702, S703, S704, and S705. The processes of steps S702 to S705 are similar to those of steps S302 to S305, respectively, in the flowchart of FIG. 14.

Next, the file/object virtualization program 131 determines whether or not the access pattern model management table 900 includes an entry of the access pattern learning model 700 of the reference destination site of the stub file (step S706). Then, if it is determined that the access pattern model management table 900 includes an entry of the access pattern learning model 700 of the reference destination site of the stub file (YES in step S706), the program proceeds to step S708, whereas if it is determined that the access pattern model management table 900 does not include an entry of the access pattern learning model 700 of the reference destination site of the stub file (NO in step S706), the program proceeds to step S707.

In step S707, the file/object virtualization program 131 creates the entry in the access pattern model management table 900, and proceeds to step S900. Meanwhile, in step S708, the file/object virtualization program 131 determines whether or not the access pattern learning model 700 of the reference destination site of the stub file is held and the expiration time of the access pattern learning model 700 thereof has not been reached. Then, if an affirmative determination is made (YES in step S708), the program is terminated (step S799), whereas if a negative determination is made (NO in step S708), the program proceeds to step S900.

A process of step S900 is the model acquisition/update process S900 described above with reference to FIG. 24.

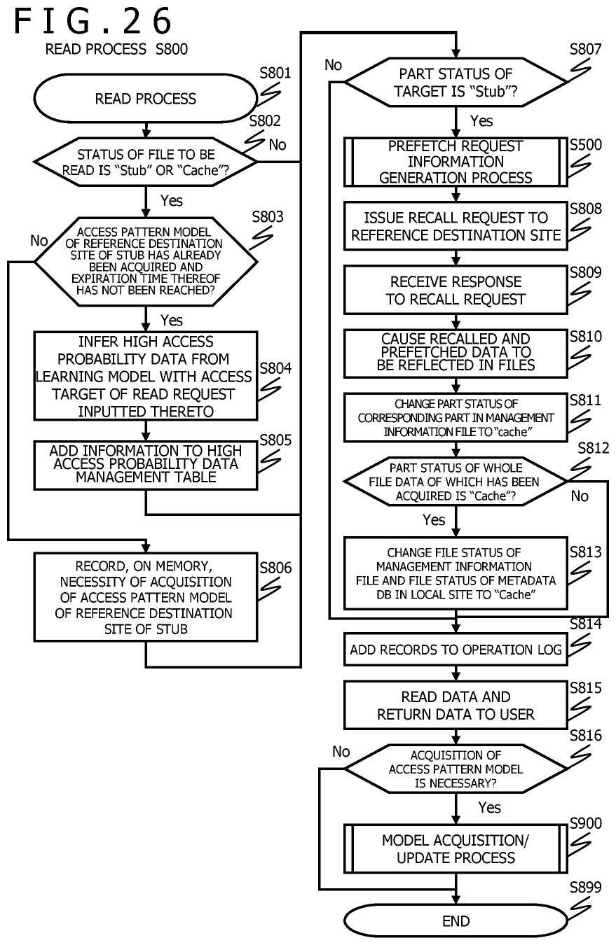

FIG. 26 is a flowchart for explaining an example of a read process of the file storage system 1 according to the fifth embodiment.

The flowchart of a read process S800 illustrated in FIG. 26 is similar to the flowchart of the read process S400 illustrated in FIG. 15, and therefore, detailed description of processes that are substantially equivalent to those in FIG. 15 will be omitted, and the equivalents in FIG. 15 will be referred to.

The read process S800 illustrated in the flowchart of FIG. 26 is also performed when a read request has been received from a client 11.

First, once the read request is received from the client 11 (step S801), the file/object virtualization program 131 determines whether or not the part status of data to be read by the read request is “Stub” or “Cache,” by referring to the part management information 350 of the management information file 300 (step S802). Then, if it is determined that the part status of the data is “Stub” or “Cache” (YES in step S802), the program proceeds to step S803, determining that the corresponding substantial file is located in another site, whereas if it is determined that the part status of the data is neither “Stub” nor “Cache” (NO in step S802), the program proceeds to step S807.

In step S803, the file/object virtualization program 131 determines whether or not the access pattern learning model 700 of the reference destination site of the stub file has already been acquired and the expiration time of the access pattern learning model 700 thereof has not been reached. Then, if an affirmative determination is made (YES in step S803), the program proceeds to step S804, whereas if a negative determination is made (NO in step S803), the program proceeds to step S806.

In step S804, the file/object virtualization program 131 inputs the data to be read by the read request into the access pattern learning model 700 acquired from the reference destination site of the stub file, and obtains high access probability data as an inference result (step S804). This high access probability data corresponds to the prefetch hint data. Next, the file/object virtualization program 131 adds information to the high access probability data management table 800 (step S805). Thereafter, the program proceeds to step S807.

Meanwhile, in step S806, the file/object virtualization program 131 records, on a memory, necessity of acquisition of the access pattern learning model 700 of the reference destination site of the stub file, and proceeds to step S807.

Processes of steps S807 to S813 are similar to those of steps S402 to S408 in the flowchart of FIG. 15. In addition, processes of steps S814 and S815 are similar to those of steps S411 and S412, respectively, in the flowchart of FIG. 15.

In step S816, the file/object virtualization program 131 determines whether or not the acquisition of the access pattern learning model 700 is necessary. This determination is made on the basis of whether or not information indicating the necessity thereof has been recorded on the memory in step S806. Then, if it is determined that the acquisition of the access pattern learning model 700 is necessary (YES in step S816), the file/object virtualization program 131 performs the model acquisition/update process S900 illustrated in FIG. 24, whereas if it is determined that the acquisition of the access pattern learning model 700 is not necessary (NO in step S816), the program is terminated (step S899).

Accordingly, the present embodiment is also able to achieve beneficial effects similar to those of the first embodiment.

Note that the features of the above-described embodiments have been described in detail to clearly describe the present invention, and that the present invention is not limited to embodiments that have all the features described above. Also, note that addition, elimination, and substitution of features are possible with respect to some of the features of each embodiment.

Also, note that the sections, functions, processing units, processing means, and so on described above may be implemented partially or entirely in hardware, for example, through designing of integrated circuits. Also, note that the present invention can also be implemented by program codes of software that implement the functions of each embodiment. In this case, a storage medium having the program codes recorded thereon is provided to a computer, and a processor included in the computer loads the program codes stored in the storage medium. In this case, the program codes themselves loaded from the storage medium implement the functions of the embodiment described above, and the program codes themselves and the storage medium having the program codes stored therein constitute embodiments of the present invention. Examples of storage media usable to provide such program codes include a flexible disk, a compact disc read-only memory (CD-ROM), a digital versatile disc (DVD)-ROM, a hard disk, a solid-state drive (SSD), an optical disk, a magneto-optical disk, a CD-R, a magnetic tape, a non-volatile memory card, and a ROM.

The program codes that implement the functions of the embodiments of the present invention described above can be implemented by a wide range of program or script languages such as an assembler, C/C++, perl, Shell, PHP, and Java (registered trademark).

Note that, in the foregoing description of the embodiments, depicted control lines and information lines are lines considered to be necessary for explanation, and that all control lines and information lines in a product may not necessarily be depicted. All components may be connected to one another.

What is claimed is:

1. A storage system comprising:
a plurality of pieces of storage equipment each including a processor and a storage apparatus that stores data, each piece of storage equipment being provided in a corresponding one of a plurality of sites connected to one another via a network,
the storage system storing pieces of the data different among the sites in a distributed manner,
the storage system allowing the storage equipment in each site to input or output data on a basis of a data input/output request received from a client, to or from the storage apparatus in the site at which data related to the data input/output request is stored, wherein
the storage equipment
acquires data stored in the site local thereto when having received a data read request for the data stored in the local site from a client or the storage equipment in another one of the sites, and transmits the acquired data to the source of the data read request, and
transmits a data read request to the storage equipment in another one of the sites to acquire data when having received a data read request for the data stored in the other site from a client, and transmits the acquired data to the client that has made the data read request,
the storage equipment generates prefetch recommendation information regarding data stored in the storage apparatus in the local site, on a basis of the data read request from the client or the storage equipment in the other site, and transmits the prefetch recommendation information to the storage equipment in the other site, and
the storage equipment that has received the prefetch recommendation information generates a prefetch request on a basis of the prefetch recommendation information, acquires the data indicated by the prefetch recommendation information from the storage equipment in the site in which the data is stored, through the prefetch request, and stores the acquired data.

2. The storage system according to claim 1, wherein the storage equipment generates access pattern information on the basis of the data read request from the client or the storage equipment in the other site, and generates the prefetch recommendation information on a basis of the access pattern information.

3. The storage system according to claim 2, wherein the access pattern information is an access pattern learning model obtained by machine learning using the data read request as learning data.

4. The storage system according to claim 1, wherein, when the data read request has been received from the storage equipment in the other site, the prefetch recommendation information is transmitted to the storage equipment in the other site together with data related to the data read request.

5. The storage system according to claim 1, wherein the acquisition of the data through the prefetch request is performed together with a data read request to the storage equipment in another one of the sites and acquisition of corresponding data.

6. The storage system according to claim 3, wherein
the prefetch recommendation information is an access pattern learning model related to the access pattern information, and
the storage equipment performs machine learning by using the access pattern learning model as the prefetch recommendation information, to generate a learning model for deciding data to be prefetched.

7. The storage system according to claim 1, wherein the prefetch recommendation information includes information indicating data for which a read request is estimated to be made following the data read request with a high probability.

8. The storage system according to claim 1, wherein the storage equipment that has received the prefetch recommendation information decides data to be prefetched and generates the prefetch request on the basis of the prefetch recommendation information.

9. The storage system according to claim 8, wherein
the storage equipment has stub data, and
the storage equipment decides the data to be prefetched so as to prefetch data corresponding to the stub data, on a basis of the prefetch recommendation information and the stub data.

10. The storage system according to claim 8, wherein the storage equipment that has received the prefetch recommendation information generates the prefetch request on a basis of the prefetch recommendation information and storage capacity that is currently available in the storage equipment itself.

11. A management method for a storage system,
the storage system including a plurality of pieces of storage equipment each including a processor and a storage apparatus that stores data, each piece of storage equipment being provided in a corresponding one of a plurality of sites connected to one another via a network,
the storage system storing pieces of the data different among the sites in a distributed manner,
the storage system allowing the storage equipment in each site to input or output data on a basis of a data input/output request received from a client, to or from the storage apparatus in the site at which data related to the data input/output request is stored,
the management method comprising:
acquiring, by the storage equipment, data stored in the site local thereto when the storage equipment has received a data read request for the data stored in the local site from a client or the storage equipment in another one of the sites, and transmitting the acquired data to the source of the data read request;
transmitting, by the storage equipment, a data read request to the storage equipment in another one of the sites to acquire data when the storage equipment has received a data read request for the data stored in the other site from a client, and transmitting the acquired data to the client that has made the data read request;
generating, by the storage equipment, prefetch recommendation information regarding data stored in the storage apparatus in the local site, on a basis of the data read request from the client or the storage equipment in the other site, and transmitting the prefetch recommendation information to the storage equipment in the other site; and
generating, by the storage equipment that has received the prefetch recommendation information, a prefetch request on a basis of the prefetch recommendation information, acquiring the data indicated by the prefetch recommendation information from the storage equipment in the site in which the data is stored, through the prefetch request, and storing the acquired data.
